(19) United States
(12) Patent Application Publication
(10) Pub. No.: US 2020/0265980 A1
(43) Pub. Date: Aug. 20, 2020

(54) SLOTTED MAGNETIC CORE AND METHOD FOR PRODUCING A SLOTTED MAGNETIC CORE

(71) Applicant: Robert Bosch GmbH, Stuttgart (DE)

(72) Inventors: Jivan Kapoor, Stuttgart (DE); Thomas Plum, Koeln (DE)

(21) Appl. No.: 16/639,831

(22) PCT Filed: Aug. 9, 2018
(86) PCT No.: PCT/EP2018/071567

§ 371 Date: Feb. 18, 2020

(30) Foreign Application Priority Data
Aug. 15, 2017 (DE) 10 2017 214 219.7

(51) Int. Cl. H01F 3/14; H01F 3/08; H01F 41/02; H01F 41/00

(52) U.S. Cl. CPC H01F 3/14; H01F 41/005; H01F 41/0246; H01F 3/08

(57) ABSTRACT

The invention relates to the production of a magnetic core having air gaps. For this purpose, according to the invention, a main body having a portion made of magnetic ferrite and a portion made of non-magnetic material is formed. Subsequently, gaps are introduced into the portion having the magnetic ferrite, while the portion having the non-magnetic material remains largely unchanged. In this way, the segments having the ferrite, which are formed by the introduction of the gaps, can be fixed relative to each other by the non-magnetic region.

### BACKGROUND OF THE INVENTION

The present invention relates to a method for producing a magnetic core, and to a magnetic core.

Document DE 10 2015 218 715 A1 discloses a current transformer module having a printed circuit board, into which an iron core is integrated in cutouts of the printed circuit board. Here, a winding which forms a secondary circuit of the current transformer module is arranged on the printed circuit board.

Inductive components are very frequently used for energy conversion for power electronics applications. Switching power supplies are one example of this. Here, magnetically soft cores with one or more gaps, in particular with air gaps, are preferably used for the inductive components.

Here, smaller and smaller inductive components are also used within the context of the miniaturization of modules. Cores with a smaller overall size are therefore also required increasingly for the inductive components.

### SUMMARY OF THE INVENTION

The present invention provides a method for producing a slotted magnetic core, in particular a winding core, and a slotted magnetic core. Accordingly, the following is provided:

A method for producing a slotted magnetic core. The method comprises a step for providing a rotationally symmetrical main body. Said rotationally symmetrical main body has a symmetry axis. The main body is of hollow configuration in an inner region around the symmetry axis, that is to say is free from material. Furthermore, in the direction of the symmetry axis of the main body, the main body has a layer structure with a first section made of a non-magnetic material and a second section with a magnetic ferrite. Furthermore, the method comprises a step for introducing gaps into the second section of the main body with the magnetic ferrite. The introduced gaps divide the second section of the main body into a plurality of segments. Here, the second section of the main body is preferably divided into a plurality of homogeneous segments.

Furthermore, the following is provided:

A slotted magnetic core having a rotationally symmetrical first section made of a non-magnetic material and a rotationally symmetrical second section with a magnetic ferrite. The first section and the second section have a common symmetry axis. Furthermore, a plurality of gaps are arranged in the second section. The gaps in the second section divide the second section into a plurality of segments. The second section is preferably divided by way of the gaps into a plurality of homogeneous segments.

The present invention is based on the finding that the production of small magnetic cores with air gaps represents a challenge. On account of the air gaps in a core, the core made of a magnetic ferrite is divided into a plurality of individual segments. In the case of a conventional core, the individual segments as a rule have no connection at all among one another. Therefore, joining together of the individual segments of a core of this type to form an overall component is a great challenge precisely in the course of miniaturization.

The present invention is therefore based on the concept of taking account of said finding and providing a method for producing slotted cores, in particular cores of a relatively small overall size, which method can firstly be realized simply and with precisely defined gap sizes, and which, moreover, provides a core which can also be further processed simply, efficiently and therefore inexpensively.

Here, in particular, it is a concept of the present invention to provide a main body as a starting basis for a slotted core, which main body, in addition to a section with a magnetic ferrite, has a further section which is non-magnetic. Said further section of the main body is therefore formed from a material which does not have any magnetic properties. Said additional section made of non-magnetic material can serve as a carrier structure which holds the region of the main body with the magnetic ferrite in a precisely defined position even when gaps, in particular air gaps, are introduced into the magnetic ferrite. In this way, the individual segments of the magnetic ferrite of the core remain fixed reliably in a position with respect to one another even when, after the introduction of the gaps into the magnetic ferrite, said section is divided into a plurality of individual segments. As a result, the core with the air gaps can be processed further in a particularly simple manner.

In particular, it is possible by way of the fixing of the individual segments with the magnetic ferrite on a non-magnetic carrier to wind a core of this type directly with wires, without it being necessary for the further segments to be fixed or connected to one another in further work steps.

Furthermore, a core according to the invention also makes the realization of cores consisting of individual ferritic segments possible, that is to say with air gaps which have a very small width of the air gaps and also very low overall dimensions.

In accordance with one embodiment, the main body comprises a further, third section with a non-magnetic material. Here, the second section with the magnetic ferrite is arranged along the symmetry axis between the first section and the third section. In this case, the step for introducing gaps can introduce the desired gaps both into the second section and into the third section, and can therefore divide the second section and the third section into a plurality of segments. In this way, the individual segments with the magnetic ferrite are covered on two opposite sides by a non-magnetic material. As a result, a wire winding which is subsequently applied can be held at a spacing from the magnetic part, that is to say the wire winding is situated outside the stray fields at the gaps in this case. In this way, the properties, for example the losses, of an inductive component with a magnetic core of this type can be improved.

In accordance with one embodiment, the step for introducing gaps comprises sawing, in particular mechanical micro-sawing, laser cutting, cutting by way of a fluid/liquid jet (for example, water jet cutting) or any other desired suitable method for introducing the gaps with the desired width. Here, in particular, methods can be used which are suitable for introducing gaps with a small gap width into the main body. Here, the width of the gaps can lie in the range of several millimeters. In this way, gaps of less than 1 mm, in particular gaps of less than 500 micrometers, 200 micrometers, less than 100 micrometers or even smaller gaps can preferably be realized.

In accordance with one embodiment, the method comprises a further step for encasing the main body with an electrically insulating material. Here, the encasing of the main body with the electrically insulating material can take place after the introducing of the gaps. In this way, the main body and therefore the slotted core can firstly be stabilized additionally. Moreover, the core can also be protected against damage by way of the encasing. Furthermore, a predefined, desired spacing between the core and a winding which is subsequently to be applied can also be realized by way of the encasing. The encasing of the main body can take place by means of any desired suitable method. For example, the encasing can take place by means of an injection molding method, by way of spraying on, evaporation deposition or another method for applying an encasing to the main body. Furthermore, it is also possible to attach an encasing consisting of one or more parts on the main body. Here, the part or parts can have been produced previously in a separate method. The attachment of the previously produced parts can take place by means of any desired suitable method, for example by way of adhesive bonding or the like.

In accordance with one embodiment, the step for encasing the main body comprises structuring of the encased main body. In this way, a slotted magnetic core can be realized which makes, for example, targeted guidance of the wire winding around the core possible by way of the structuring of the encasing. Furthermore, it is possible as a result to also set a defined spacing from a component housing which is applied later. Moreover, for example during the encasing and/or the structuring, electric connectors for a winding around the core can also be applied at the same time.

In accordance with one embodiment, the providing of the main body comprises pressing of the starting materials into a desired shape. Furthermore, the providing of the main body can also comprise sintering of the main body, in particular the combination of magnetic ferrite and non-magnetic material. In this way, a main body can be formed, in the case of which the magnetic ferrite and the non-magnetic material already form one unit. This makes particularly simple further processing possible.

In accordance with one embodiment, the gaps of the core have a width of a few millimeters, 1 mm or less than 1 mm. In particular, the gaps can have a width of less than 500 micrometers, less than 200 micrometers, less than 100 micrometers or possibly also 50 micrometers, 20 micrometers or less. Here, the number of gaps which are introduced can be selected in any desired way. In particular, for example, one, two, three, four, six, eight or any other number of gaps which differs therefrom are possible. Here, the core can have a diameter of a few millimeters, in particular a few centimeters. The height of the core can likewise be a few millimeters, or one or more centimeters. Here, the height of the core is considered to be the core dimension along the symmetry axis, whereas the width of the core is considered to be the dimension in the radial direction perpendicularly with respect to the symmetry axis.

In accordance with one embodiment, the core comprises a second section with magnetic ferrite which, as viewed in the direction of the symmetry axis, is arranged between two sections consisting of a non-magnetic material.

In accordance with one embodiment, the core is encased at least partially with an electrically insulating material.

In accordance with one embodiment of the core, the gaps have a variable width in the radial direction and/or in a direction parallel to the symmetry axis. In this way, the inductance value of the magnetic core can be designed in a current-dependent manner. This leads, in particular, to a load-dependent efficiency and associated advantages.

The above refinements and developments can be combined with one another as desired, in so far as this is appropriate. Further refinements, developments and implementations of the invention also comprise combinations which have not been mentioned explicitly of features of the invention which are described above or in the following text with regard to the exemplary embodiments. In particular, a person skilled in the art will also add individual aspects as improvements or additions to the respective basic forms of the present invention.

### BRIEF DESCRIPTION OF THE DRAWINGS

In the following text, the present invention will be described in greater detail on the basis of the exemplary embodiments which are indicated in the diagrammatic figures of the drawings, in which:

FIG. 1 shows a diagrammatic illustration of a cross section through a slotted magnetic core in accordance with one embodiment,

FIG. 2 shows a diagrammatic illustration of a plan view of a slotted magnetic core in accordance with one embodiment,

FIG. 3 shows a perspective illustration of a slotted magnetic core in accordance with one embodiment,

FIG. 4 shows a perspective illustration of a slotted magnetic core in accordance with a further embodiment, and

FIG. 5 shows an illustration of a flow chart, as forms the basis of a method for producing a slotted magnetic core in accordance with one embodiment.

### DETAILED DESCRIPTION

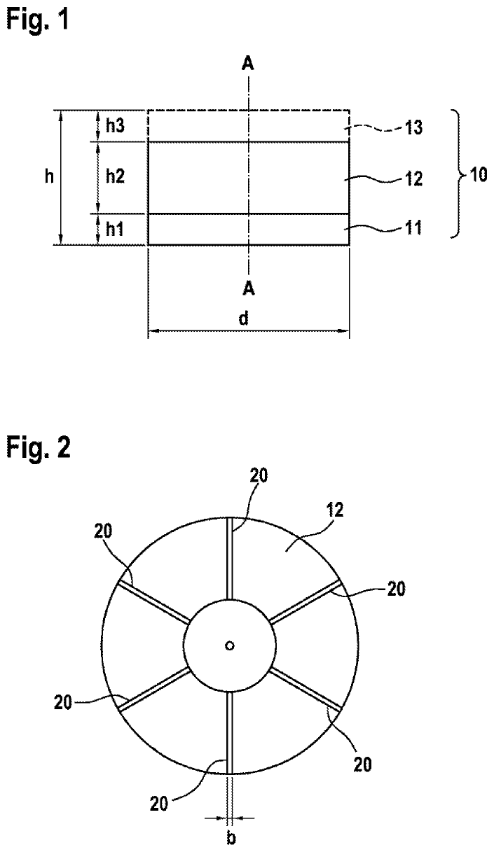

FIG. 1 shows a diagrammatic illustration of a cross section through a main body 10 for producing a slotted magnetic core, as forms the basis of one exemplary embodiment of the present invention. The main body 10 is a rotationally symmetrical main body which has at least one symmetry axis A-A. In this context, rotationally symmetrical means that the main body 10 can be transformed into itself by way of rotation about the symmetry axis A-A by a predefined angle. Here, the predefined angle is 360° n, n being a natural number of 2 or more. In particular, the main body 10 can therefore have the base area of a regular polygon. Moreover, circular base areas for the main body 10 or else, for example, oval base areas are also possible.

In the example which is shown here, the main body has a constant width d along the symmetry axis A-A. This serves merely for improved comprehension and is not absolutely necessary for the formation of a main body 10.

Here, the main body 10 is formed from a first section 11 and a second section 12. Here, the first section 11 consists of a non-magnetic material. For example, the first section 11 can be formed from a non-magnetic ceramic or another suitable material with non-magnetic properties. The first section 11 is adjoined directly by the second section 12 along the symmetry axis A-A. Said second section 12 consists completely or at least predominantly from magnetic ferrite. Any desired, suitable ferrites are possible here.

For example, the main body 10 can be produced by way of pressing of a non-magnetic starting material for the first section 11 and a magnetic material for the second section 12. The main body 10 can possibly be sintered in a further process step after the pressing of the starting materials. Corresponding process steps for producing the pressing and/or sintering can be configured in a conventional way here.

As an alternative, it is also possible for the individual sections 11 and 12 to first of all be produced separately and for the individual sections 11 and 12 to subsequently be joined together to form a common main body 10. The joining together can be realized, for example, by way of adhesive bonding or another suitable method process. In every case, the first section 11 and the second section 12 should be connected fixedly to one another.

A third section 13 (shown using dashed lines here) can possibly also adjoin the first section 11 and the second section 12 along the symmetry axis A-A. Said optional third section 13 can consist of a non-magnetic material in an analogous manner with respect to the first section 11.

As has already been stated above, the main body 10 has a rotationally symmetrical shape. Here, the main body 10 is hollow in the interior. This means that, as viewed radially to the outside from the symmetry axis A-A, there is first of all a material-free region which is adjoined subsequently by a region consisting of magnetic ferrite in the second section 12 and/or non-magnetic material in the first section 11. In the case of a circular base area for the main body 10, a hollow cylinder can therefore be formed by way of the main body 10.

The main body 10 preferably has a diameter d of a few millimeters. For example, the main body 10 can have a diameter d of 1 cm, 1.5 cm, 2 cm, 3 cm or 5 cm. Greater or smaller diameters d are fundamentally also possible, however. The height h of the main body 10 can likewise be a few millimeters. For example, the height h of the main body can be 5 mm, 10 mm, 15 mm or 20 mm. Smaller or greater heights are also possible here for the main body 10, however. In particular, the height hl of the first section 11 and the height h3 of the optional third section 13 can lie in the range of one or a few millimeters. Thus, for example, heights of 0.8 mm, 1 mm, 1.5 mm or 2 mm are possible for the first and the optional third section 11, 13.

FIG. 2 shows a diagrammatic illustration of a plan view of a slotted magnetic core 1 in accordance with one embodiment. As can be seen in FIG. 2, one or more gaps 20 are introduced into the main body 10, and here, in particular, into the second section 12.

The introduction of the gaps 20 into the second section 12 of the main body 10 can take place, for example, by means of sawing, in particular by means of micro-sawing. Any other desired methods are also possible, however, such as structuring by means of a laser beam or cutting by means of a fluid/liquid jet, for example a water jet. Other known or novel methods are also possible for the introduction of the gaps 20 into the main body 10. The width b of the gaps can lie, for example, in the range of one or more millimeters. The gaps 20 preferably have a width b of less than 1 mm. For example, the gaps 20 can have a width of 500 micrometers, 200 micrometers, 150 micrometers, 100 micrometers or less. Gaps with a width b of 50 micrometers, 20 micrometers or 10 micrometers are also possible. The width b of the gaps 20 is preferably smaller than a width of a wire which is to be wound around the magnetic core 1 later. It can be ensured in this way that the wire does not slip into a gap 20 during winding.

In the exemplary embodiment which is shown here, the width b of the gaps 20 is constant in the radial direction and parallel to the symmetry axis A-A. Moreover, it is also possible to vary the width b of the gaps 20 in the radial direction and/or parallel to the symmetry axis A-A. For example, the individual gaps 20 can have a plurality of sections with a different width b. This method can increase (or decrease) the width b of a gap 20 in the radial direction and/or parallel to the symmetry axis A-A in a stepped manner. This can be achieved, for example, by virtue of the fact that the introduction of the gaps 20 into the main body 10 takes place in a plurality of steps. For example, different cutting widths for the gaps 20 can be machined successively in a plurality of steps, in each case the depth for the machining of the gap being decreased as the cutting width increases. For example, gaps with a different width can be sawed or cut successively into the main body 10, gaps with a smaller width being introduced more deeply into the main body 10, whereas gaps with a greater width are introduced less deeply into the main body 10. As an alternative, the width b of the gaps 20 can also be varied continuously in the radial direction or parallel to the symmetry axis A-A.

The inductance value of the magnetic core 1 can be designed in a current-dependent manner by way of a variation of the width b of the gaps 20. This leads, in particular, to a load-dependent efficiency of applications with a corresponding magnetic core 1.

Depending on the application, any desired number of gaps 20 is possible. In principle, a core with only one gap 20 can be realized. The core 1 preferably has a plurality of gaps 20, however, for example two, three, four, six, eight or any other desired number of gaps 20. At least the second section 12 is divided into a plurality of segments by way of the gaps 20 which are introduced into the main body 20 and, in particular, into the second section 12. Here, the second section 12 is preferably divided into a plurality of homogeneous segments. In this way, the magnetic core 1 can have a rotationally symmetrical structure with the same symmetry axis A-A even after the introduction of the gaps 20. In the example which is shown here, the gaps 20 are arranged in the main body 10 homogeneously, that is to say equidistantly. An equidistant distribution of this type of the gaps 20 is not absolutely necessary, however. As an alternative, it is also possible for a cluster of gaps 20 to be provided in one section of the main body 10. In this case, the individual segments of the main body 10 do not all have the same shape.

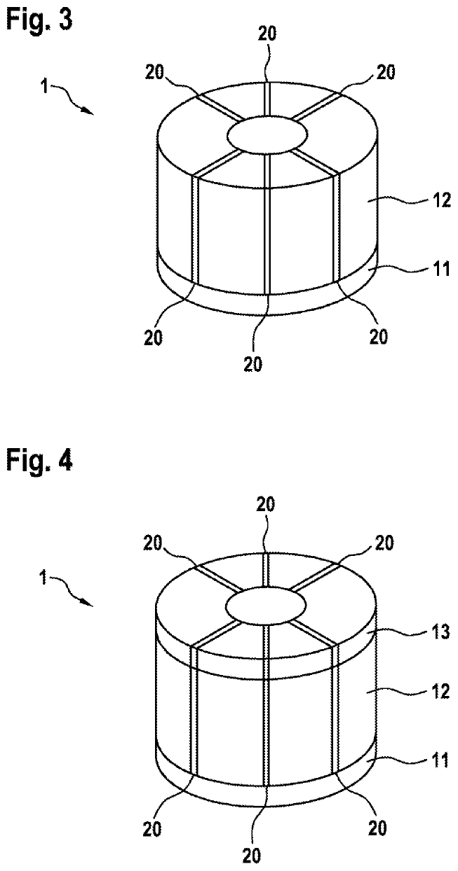

FIG. 3 shows a perspective view of a slotted magnetic core 1 in accordance with one embodiment. In said embodiment, the magnetic core 1 is produced from a main body 10 with only a first section 11 and a second section 12. As can be seen here, the gaps 20 are introduced into the main body 10 only in the region of the second section 12. No gaps 20 are introduced in the region of the first section 11 made of the non-magnetic material. In this way, the second section 12 is divided into a plurality of segments which are fixed to one another by way of the first section 11 on account of the connection between the first section 11 and the second section 12.

FIG. 4 shows a perspective illustration of a slotted magnetic core 1 in accordance with a further embodiment. In said embodiment, the core 1 is formed from a main body 10 with a first section 11, a second section 12 and a third section 13. In this case, the gaps 20 are introduced both into the second section 12 and into the third section 13. No gaps 20 are introduced merely in the first section 11, with the result that the segments of the second section 12 and the third section 13 are fixed to one another by way of the connection to the first section 11.

In principle a magnetic core 1 (as has already been described above) can already be wound with wire, in order to form an inductance in this way. Moreover, an above-described core 1 can also additionally be encased by a material, in particular an electrically non-conducting material. Here, the above-described core 1 can be encased completely by a suitable electrically non-conducting material. Moreover, depending on the application, merely partial encasing of the above-described core 1 is also possible.

The encasing of the main body can be carried out by means of any desired suitable method. For example, the encasing can be carried out by means of a suitable injection molding method (for example, by means of in mold methods) or the like. Moreover, any desired other methods for complete or partial encasing are also possible. For example, powder coating or a CVD (Chemical Vapor Deposition) method is possible. The magnetic core 1 can first of all be protected against damage by way of the encasing. Moreover, the structure of the core 1 with the gaps 20 can be additionally stabilized by way of the encasing. In particular, it is also possible that the material for the encasing also penetrates into the gaps 20. As an alternative, merely the outer region of the core 1 can also be encased, whereas the gaps 20 remain filled with air even after the encasing.

Furthermore, it is also possible for an encasing consisting of one or more parts to be attached to the main body 10. Here, the part or parts to be attached can be produced beforehand. To this end, for example, plastic parts can be manufactured separately. Said separate plastic parts can also be produced, for example, by means of an injection molding method. The attachment of the separate parts can be carried out by means of any desired suitable method. For example, the parts can be fixed on the main body 10 by way of adhesive bonding or the like.

In addition, it is also possible within the course of the encasing for the encasing to be structured. In this way, for example, guidance of the wires and/or strip conductors for the formation of an inductance can be predefined by way of suitable structuring. Furthermore, together with the encasing of the core 1, an element for an electric connection of wires for winding around the core can also be provided. In particular, a holder for electric connectors can be provided, for example, in the case of an encasing by means of injection molding methods.

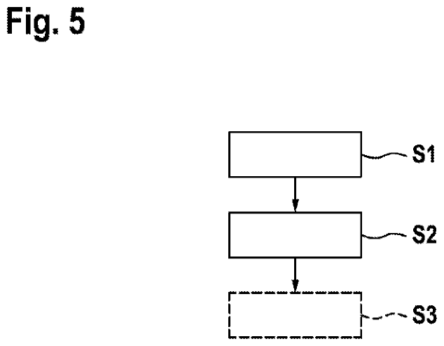

FIG. 5 shows a flow chart, as forms the basis for a method for producing a slotted magnetic core 1 in accordance with one embodiment. In step S1, a main body 10 is first of all provided. Here, the main body 10 can have the properties of a main body 10 which have already been described above. In particular, the main body 10 can have a rotationally symmetrical shape. Furthermore, the main body 10 comprises at least one first section 11 made of a non-magnetic material and a second section 12 with a magnetic ferrite. The providing of the main body 10 also comprises, for example, the pressing of the magnetic ferrite and the non-magnetic material to form a common pressed blank, and possibly also the sintering of the combination of non-magnetic material and magnetic ferrite. As a result, a stable connection between the two sections 11, 12 can be achieved. If the main body 10 is to comprise an optional third section 13, as has already been described above, said third section 13 can also be pressed and/or sintered together with the two other sections.

In step S2, gaps 20 are introduced into the provided main body 10. Here, the gaps 20 are introduced merely into the second section and possibly into the optional third section 13. Expressly no gaps are introduced into the first section 11, with the result that the resulting slotted magnetic core 1 has a plurality of segments with a magnetic ferrite, which segments are fixed by way of the contiguous non-magnetic section 11.

In a further step S3, the main body 10 with the gaps 20 can optionally be encased by a material, in particular an electrically insulating material. In this way, the magnetic core 1 which is formed is stabilized and is protected against damage.

In summary, the present invention relates to the production of a slotted magnetic core with air gaps. To this end, it is provided for a main body with a section made of magnetic ferrite and a section made of non-magnetic material to be formed. Subsequently, gaps are introduced into the section with the magnetic ferrite, whereas the section of the non-magnetic material remains unchanged as far as possible. In this way, the segments with the ferrite which are formed by way of the introduction of the gaps can be fixed against one another by way of the non-magnetic region.

1. A method for producing a slotted magnetic core (1), the method comprising the steps:
providing (S1) a rotationally symmetrical main body (10) with a symmetry axis (A-A), the main body (10) being hollow in an inner region about the symmetry axis (A-A), and the main body (10) comprising, in the a direction of the symmetry axis (A-A), a first section (11) made of a non-magnetic material and a second section (12) made of a magnetic ferrite; and
introducing (S2) gaps (20) into the second section (12) of the main body (10), the gaps (20) dividing the second section (12) of the main body (10) into a plurality of segments.

2. The method as claimed in claim 1, the main body (10) comprising a third section (13) made of a non-magnetic material, and the second section (12) being arranged along the symmetry axis (A-A) between the first section (11) and the third section (13); and the step (S2) for introducing the gaps (20) dividing the second section (12) and the third section (13) into a plurality of segments.

3. The method as claimed in claim 1, the step (S2) for introducing the gaps (20) comprising sawing, laser cutting and/or cutting by way of a fluid jet.

4. The method as claimed in claim 1, the method also comprising a step (S3) of encasing the main body (10) with an electrically insulating material after the step (S2) for introducing the gaps (20).

5. The method as claimed in claim 4, the step (S3) for encasing the main body (10) comprising structuring of the encased main body (10).

6. The method as claimed in claim 1, the step (S1) for providing the main body (10) comprising pressing and/or sintering of the main body (10).

7. A slotted magnetic core (1), comprising:
a rotationally symmetrical first section (11) made of a non-magnetic material, and
a rotationally symmetrical second section (12) with a magnetic ferrite,
the first section (11) and the second section (12) having a common symmetry axis (A-A), and a plurality of gaps (20) being arranged in the second section (12), which gaps (20) divide the second section (12) into a plurality of segments.

8. The slotted magnetic core (1) as claimed in claim 7, the gaps (20) in the second section (12) having a width (b) of less than 200 micrometers.

9. The slotted magnetic core (1) as claimed in claim 7, the magnetic core (1) comprising a third section (13) made of a non-magnetic material, and the second section (12) being arranged between the first section (11) and the third section (13).

10. The slotted magnetic core (1) as claimed in claim 7, the magnetic core (1) comprising an electrically insulating encasing.

11. The slotted magnetic core as claimed in claim 7, the gaps (20) having a variable width (b) in a radial direction and/or in a direction parallel to the symmetry axis (A-A).
